(19) United States
(12) Patent Application Publication
(10) Pub. No.: US 2025/0303712 A1
(43) Pub. Date: Oct. 2, 2025

(54) LIQUID EJECTING HEAD AND LIQUID EJECTING APPARATUS

(71) Applicant: SEIKO EPSON CORPORATION, Tokyo (JP)

(72) Inventor: Keita MORIYAMA, MATSUMOTO-SHI (JP)

(21) Appl. No.: 19/087,690

(22) Filed: Mar. 24, 2025

(30) Foreign Application Priority Data
Mar. 27, 2024 (JP) 2024-052506

(51) Int. Cl. B41J 2/14; B41J 29/46

(52) U.S. Cl. CPC B41J 2/14233; B41J 29/46; B41J 2002/14491

(57) ABSTRACT

A liquid ejecting head includes a head chip, a cover to which the head chip is fixed, and a detection element configured to detect a deformation of the cover.

The present application is based on, and claims priority from JP Application Serial Number 2024-052506, filed Mar. 27, 2024, the disclosure of which is hereby incorporated by reference herein in its entirety.

### BACKGROUND

### 1. Technical Field

The present disclosure relates to a liquid ejecting head including a head chip that ejects a liquid and a liquid ejecting apparatus.

### 2. Related Art

In the past, known is the liquid ejecting apparatus, as typified by an ink jet printer, including a liquid ejecting head that ejects a liquid such as ink.

A liquid ejecting head includes a head chip with a plurality of nozzles from which droplets are ejected, a holder that holds the head chip, and a cover (fixing plate) that protects the droplet ejection face of the head chip (see, for example, JP-A-2022-42753 A).

However, the cover may be deformed due to the medium colliding with the cover or other causes, resulting in a printing defect. Therefore, it is desirable to detect cover deformation.

### SUMMARY

According to an aspect of the present disclosure, a liquid ejecting head includes a first head chip that ejects a liquid, a cover having a first face and a second face that is a face opposite the first face and to which the first head chip is fixed, and a first detection element that detects a deformation of the cover.

According to another aspect of the present disclosure, a liquid ejecting apparatus includes the liquid ejecting head according to the aspect, and a notification unit that notifies a user that an anomaly has occurred in the liquid ejecting head based on a detection signal from the first detection element.

### BRIEF DESCRIPTION OF THE DRAWINGS

FIG. 1 is a perspective view showing the appearance of a liquid ejecting apparatus according to the first embodiment.

FIG. 2 is a diagram showing a schematic configuration of the liquid ejecting apparatus according to the first embodiment.

FIG. 3 is exploded perspective view of a liquid ejecting head according to the first embodiment.

FIG. 4 is an exploded perspective view of the liquid ejecting head according to the first embodiment.

FIG. 5 is a plan view of part of the liquid ejecting head according to the first embodiment.

FIG. 6 is a cross-sectional view of the main part of the liquid ejecting head according to the first embodiment.

FIG. 7 is a cross-sectional view of the main part of the liquid ejecting head according to the first embodiment.

FIG. 8 is a cross-sectional view of the main part of the liquid ejecting head according to the first embodiment.

FIG. 9 is a plan view of a cover according to the first embodiment.

FIG. 10 is a cross-sectional view of a head chip according to the first embodiment.

FIG. 11 is a block diagram showing the electrical configuration of the liquid ejecting apparatus according to the first embodiment.

FIG. 12 is a block diagram illustrating a function implementing unit according the first embodiment.

FIG. 13 is a graph showing the relationship between the displacement of the cover and the voltage output by the detection element.

FIG. 14 is a plan view of a cover according to the second embodiment.

FIG. 15 is a cross-sectional view of the main part of a modification of the liquid ejecting head.

FIG. 16 is an enlarged cross-sectional view of the main part of a modification of the liquid ejecting head.

FIG. 17 is a cross-sectional view of the main part of a modification of the liquid ejecting head.

### DESCRIPTION OF EMBODIMENTS

The present disclosure is described in detail below based on the embodiment. However, the following description is only an aspect of the present disclosure and can be modified as desired within the scope of the present disclosure. In each figure, items with the same symbol indicate identical components, and explanations are omitted where appropriate. In each figure, X, Y, and Z represent the three mutually orthogonal spatial axes. In this specification, the directions along these axes are the X, Y, and Z directions. The direction of the arrow in each figure is described as the positive (+) direction and the direction opposite the direction of the arrow as the negative (−) direction. The Z direction indicates the vertical direction, with the +Z direction indicating a vertically downward direction and the −Z direction indicating vertically upward direction. Furthermore, the three spatial axis directions that do not have the limitation of positive and negative directions are described as the X axis direction, the Y axis direction, and the Z axis direction.

### First Embodiment

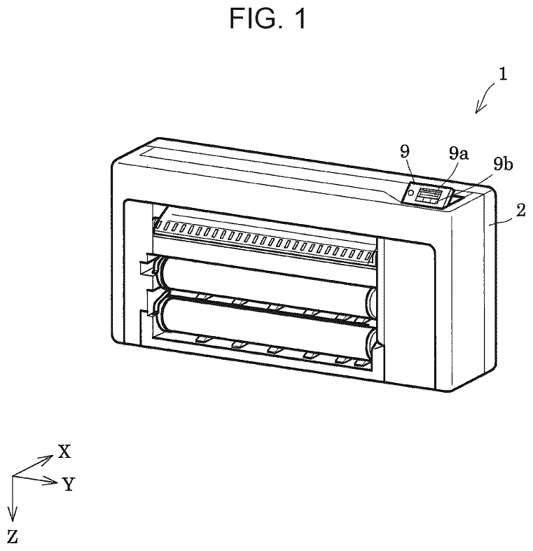

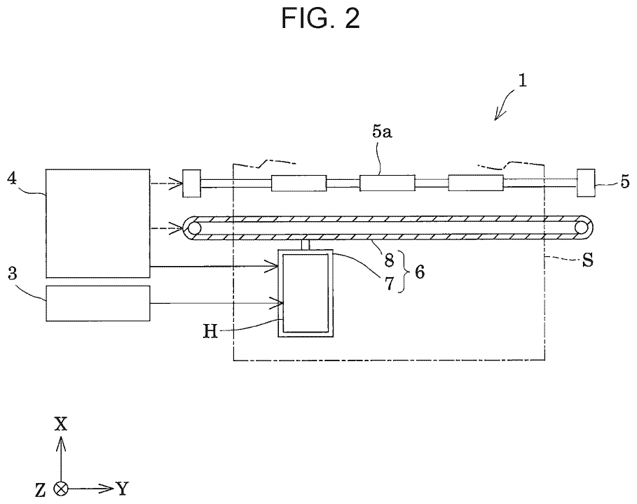

FIG. 1 shows an external view of a liquid ejecting apparatus 1 according to the first embodiment of the present disclosure. FIG. 2 is a diagram showing a schematic configuration of the liquid ejecting apparatus 1.

As shown in the figure, the liquid ejecting apparatus 1 is a so-called serial printer that includes a liquid ejecting head H and performs prints by ejecting a liquid from the liquid ejecting head H toward a medium S in the +Z direction while transporting the medium S in the X axis direction and causing the liquid ejecting head H to reciprocate in the Y axis direction. The medium S may include any material such as recording paper or a resin film, in addition to cloth.

The liquid ejecting apparatus 1 includes the liquid ejecting head H, a liquid reservoir 3, a control unit 4 that is a controller, a transport mechanism 5 that feeds the medium S, a movement mechanism 6, and a housing 2 that houses these components therein.

The liquid ejecting head H ejects, as droplets, a liquid supplied from the liquid reservoir 3 that stores a liquid in the +Z direction.

The liquid reservoir 3 stores a plurality of types of liquids with different colors separately and compositions, where the liquids are to be ejected from the liquid ejecting head H. The liquid reservoir 3 includes, for example, a cartridge that can be attached to and detached from the liquid ejecting apparatus 1, a bag-shaped ink pack made of a flexible film, and an ink tank that can be refilled with ink. In FIG. 2, one liquid reservoir 3 is shown as an example. The liquid reservoir 3 may be a liquid reservoir having divided rooms that store a plurality of types of liquids separately, or may be a plurality of the liquid reservoirs provided separately for a plurality of respective types of liquids. The liquid reservoir 3 may be divided into a main tank and a sub-tank. The configuration may be such that the sub-tank communicates with the liquid ejecting head H and the sub-tank is replenish from the main tank by the amount of a liquid consumed by ejecting droplets from the liquid ejecting head H.

The control unit 4 comprehensively controls respective components of the liquid ejecting apparatus 1, that is, the liquid ejecting head H, the transport mechanism 5, the movement mechanism 6, and the like.

The transport mechanism 5 transports the medium S in the X axis direction and includes a transport roller 5a. The transport mechanism 5 transports the medium S in the X axis direction by rotating the transport roller 5a. The transport roller 5a is rotated by driving a transport motor (not shown). The control unit 4 controls the transport of the medium S by controlling the drive of the medium transport motor. The transport mechanism 5 that transports the medium S is not limited to the one including the transport roller 5a, but may be a mechanism that transports the medium S using, for example, a belt or a drum.

The movement mechanism 6 is a mechanism for causing the liquid ejecting head H to reciprocate in the Y axis direction and includes a holding body 7 and a transport belt 8. The holding body 7 is a so-called carriage that holds the liquid ejecting head H and is fixed to the transport belt 8. The transport belt 8 is an endless belt disposed along the Y axis direction. The transport belt 8 is rotated by driving a drive motor (not shown). The control unit 4 controls the drive of the transport motor to rotate the transport belt 8 and causes the liquid ejecting head H together with the holding body 7 to reciprocate in the Y axis direction. The holding body 7 may be configured to mount the liquid reservoir 3 together with the liquid ejecting head H.

The housing 2 includes an operation panel 9 fixed to the periphery thereof. The operation panel 9 includes a display device 9a, which is an example of a display unit, and an operation device 9b, which is an example of a reception unit that receives an instruction from the user. The display device 9a includes, for example, a liquid crystal display, an organic EL display, an LED lamp, and the like, and displays various pieces of information. The operation device 9b includes various switches that can receive input from the user. Examples of switches on the operation device 9b include, for example, a direction switch to operate the cursor position, a decision switch to make a decision, a cancel switch, and a power switch. The display device 9a may be a touch panel that can receive input from the user. In the case of a touch panel, the touch panel serves as both a display unit and a reception unit.

The liquid ejecting apparatus 1 includes a maintenance unit that maintains the liquid ejecting head H, although not specifically shown in the figure. The maintenance unit includes, for example, a wiper that wipes the ejection face of the liquid ejecting head H. The maintenance unit may include a cap covering the ejection face of the liquid ejecting head H and a suction unit that suctions the inside of the cap, and performs suction cleaning in which liquid and other substances inside the liquid ejecting head H are suctioned through the cap by the suction unit. The maintenance unit may include a moisture retaining cap that covers the ejection face of the liquid ejecting head H and prevents the liquid near the nozzles 21 from drying out.

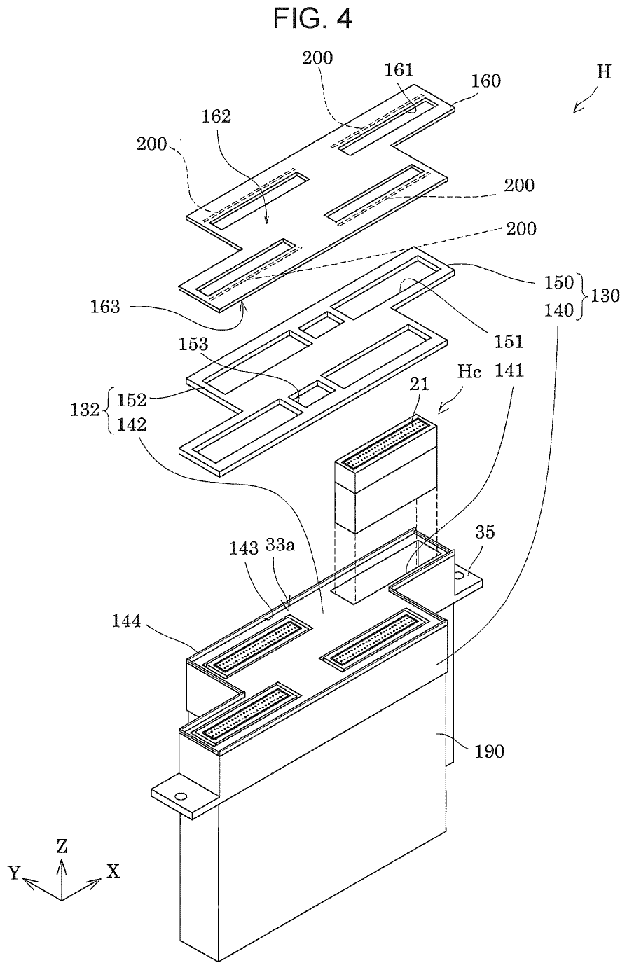

Under control by the control unit 4, the liquid ejecting head H performs an ejection operation of ejecting a liquid, as droplets, supplied from the liquid reservoir 3 in the +Z direction from each of the plurality of nozzles 21 (see FIG. 4). The ejection operation by the liquid ejecting head H is performed in parallel with the transport of the medium S by the transport mechanism 5 and the reciprocating movement of the liquid ejecting head H by the movement mechanism 6, so that the medium S is coated with the liquid, that is, printing is performed.

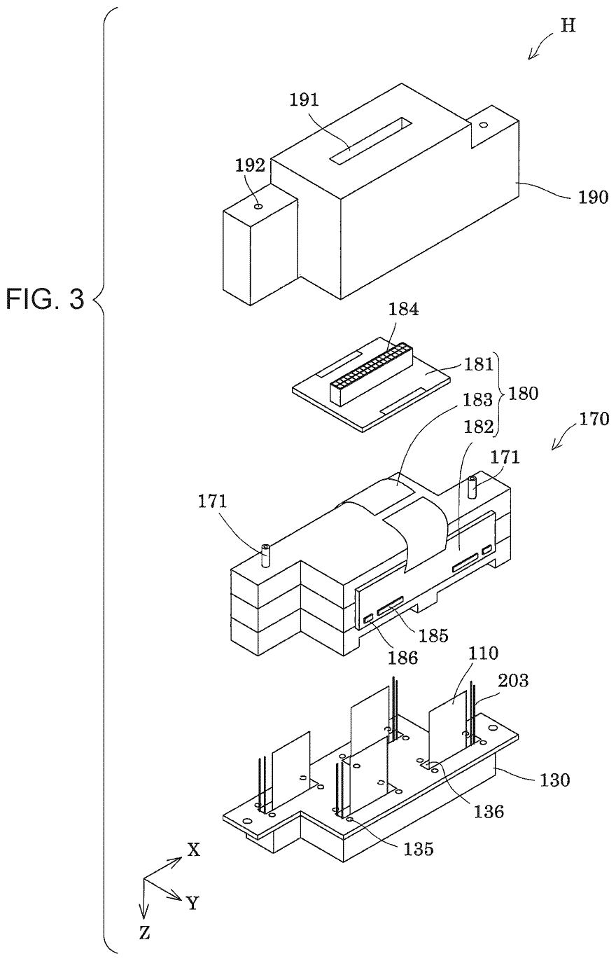

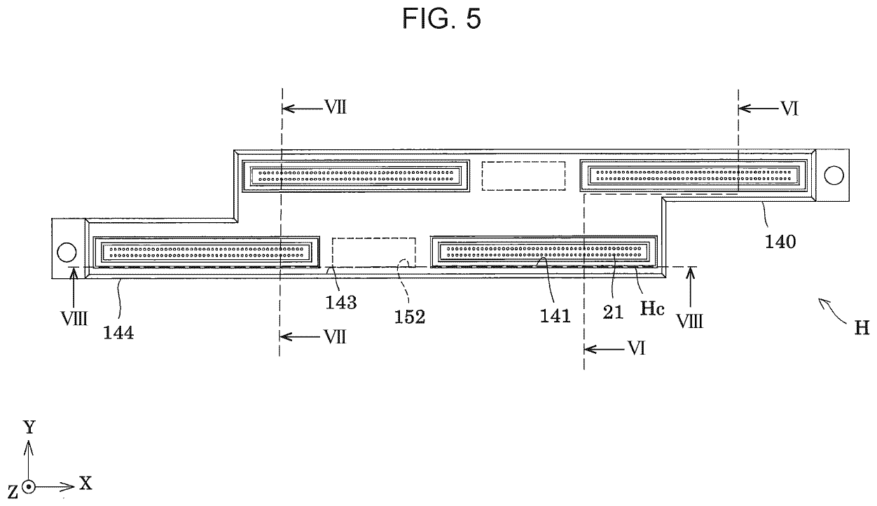

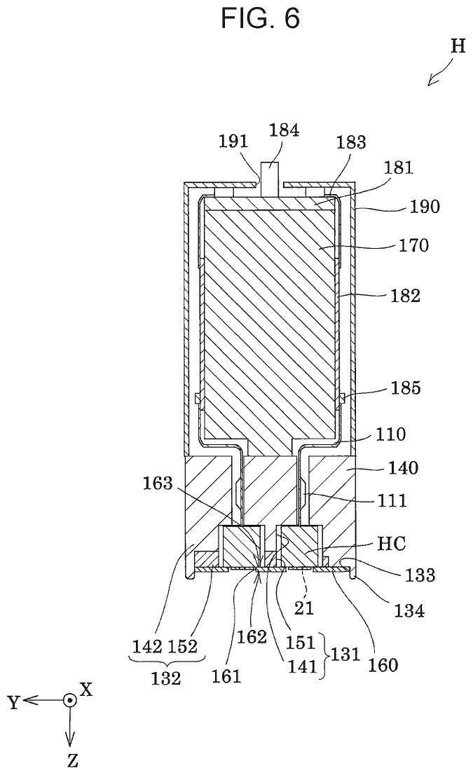

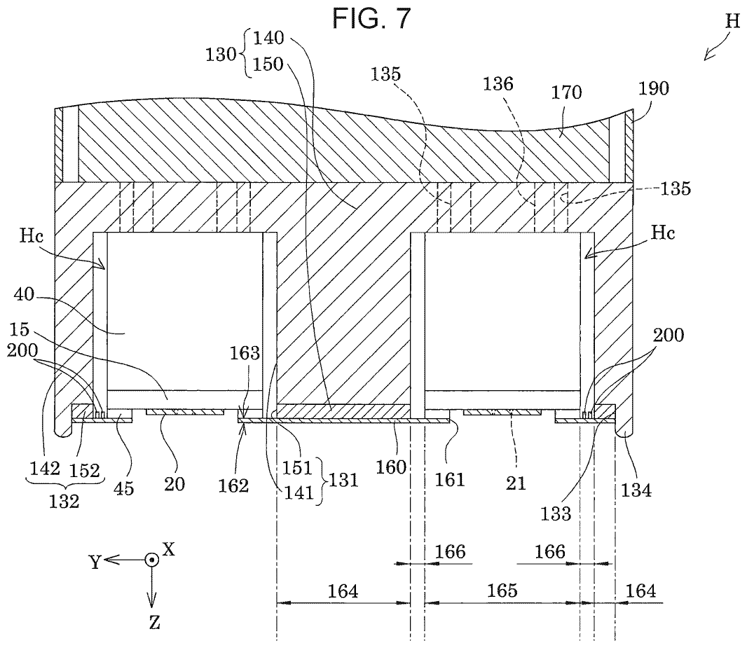

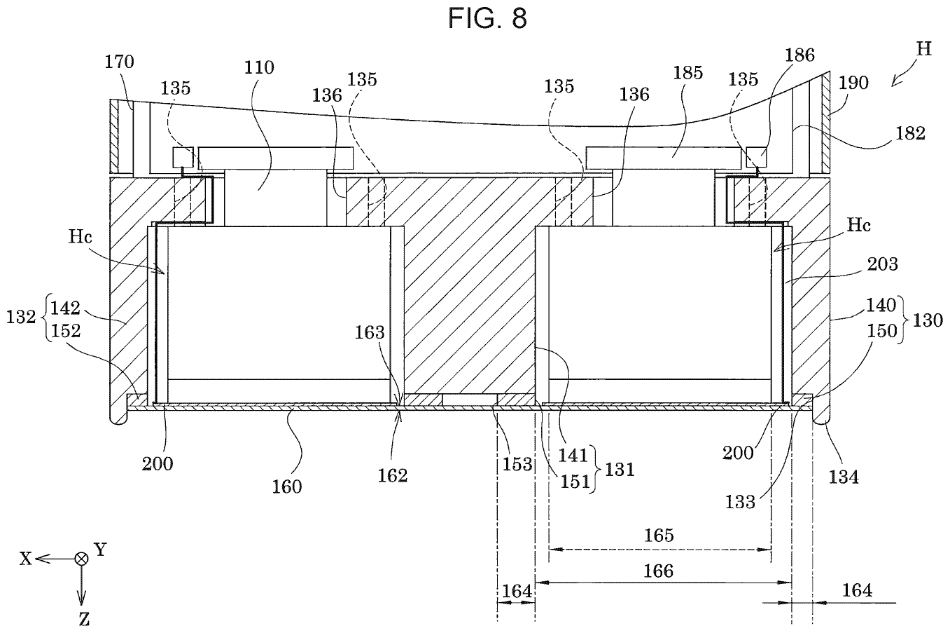

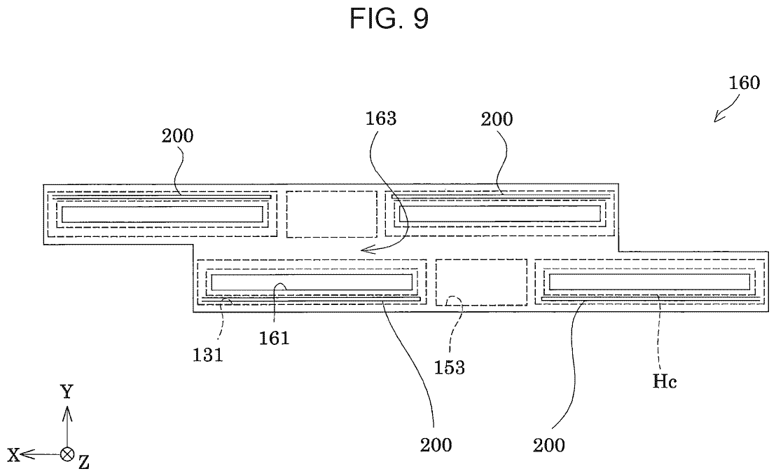

FIG. 3 is an exploded perspective view of the liquid ejecting head H according to the first embodiment when viewing the +Z direction. FIG. 4 is an exploded perspective view of the liquid ejecting head H when viewing the −Z direction. FIG. 5 is a plan view of a holder 130 of the liquid ejecting head H when viewing the −Z direction. FIG. 6 is a cross-sectional view of the liquid ejecting head H taken along line VI-VI in FIG. 5. FIG. 7 is a cross-sectional view of the liquid ejecting head H taken along line VII-VII in FIG. 5. FIG. 8 is a cross-sectional view of the liquid ejecting head H taken along line VIII-VIII in FIG. 5. For convenience of explanation, a second region 165 described below, which is located in the +Y direction shifted from the cutting position shown in FIG. 8, is illustrated in dashed lines in FIG. 8. FIG. 9 is a plan view of a cover 160 when viewing the +Z direction. Each direction of the liquid ejecting head H is described based on the direction when the liquid ejecting head H is mounted on the liquid ejecting apparatus 1, that is, the X axis direction, the Y axis direction, and the Z axis direction.

As shown in the figure, the liquid ejecting head H includes a plurality of head chips Hc with nozzles 21 from which ink droplets are ejected, the holder 130 that holds the head chips Hc, a flow path member 170 for supplying ink to the head chips Hc, a relay board 180 on which wiring for transmitting and receiving control signals and the like to the head chips Hc is mounted, and a cover member 190 that accommodates the flow path member 170 therein.

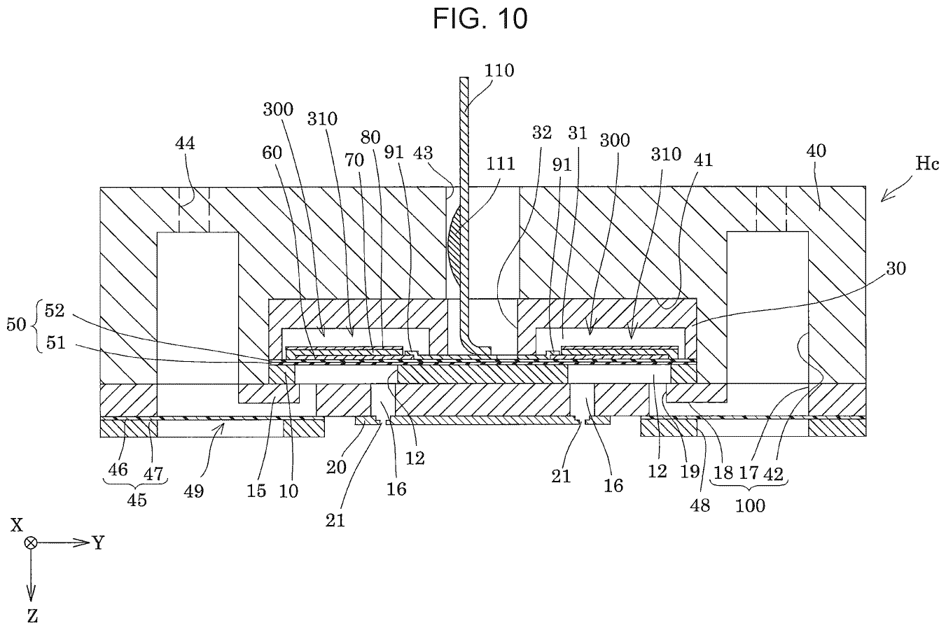

FIG. 10 is a cross-sectional view of the head chip Hc. Each direction of the head chip Hc is described based on the direction when the head chip Hc is mounted on the liquid ejecting head H, that is, the X axis direction, the Y axis direction, and the Z axis direction.

As shown in the figure, the head chip Hc includes a flow path forming substrate 10, a communicating plate 15, a nozzle plate 20 with a plurality of nozzles 21, a protection substrate 30, a case member 40, and a piezoelectric actuator 300.

The flow path forming substrate 10 is made of, for example, a silicon substrate. A plurality of pressure chambers 12 is disposed side by side along the X axis direction in the flow path forming substrate 10. The plurality of pressure chambers 12 is disposed in a straight line along the X axis direction so that they are at the same position with respect to the Y axis direction. In the present embodiment, two rows of pressure chambers are provided in the Y axis direction, with pressure chambers 12 aligned along the X axis direction. Each of the pressure chambers 12 constituting the two rows of pressure chambers is disposed at the same position in the X axis direction. The two rows of pressure chambers may be disposed with half the pitch of the pressure chambers 12, or the so-called half pitch, offset from each other in the X axis direction. In other words, all pressure chambers 12 in the two rows of pressure chambers may be disposed in a staggered configuration along the X axis direction.

The communicating plate 15 and the nozzle plate 20 are sequentially stacked on the face, of the flow path forming substrate 10, facing the +Z direction. A vibration plate 50 and the piezoelectric actuator 300 are sequentially stacked on the face, of the flow path forming substrate 10, facing the −Z direction.

The communicating plate 15 is made of a plate member joined to the face, of the flow path forming substrate 10, facing the +Z direction. The communicating plate 15 has a nozzle communicating passage 16 that communicates the pressure chamber 12 with the nozzle 21. The communicating plate 15 has a first manifold portion 17 and a second manifold portion 18 that constitute part of a manifold 100 that serves as a common liquid chamber through which the plurality of pressure chambers 12 is commonly communicated. The first manifold portion 17 penetrates the communicating plate 15 in the Z axis direction. The second manifold portion 18 does not penetrate the communicating plate 15 in the Z axis direction, but is open to the face facing the +Z direction. In addition, the communicating plate 15 independently has a supply communicating passage 19 that communicates with the pressure chambers 12 for each of the pressure chambers 12. The supply communicating passage 19 communicates the second manifold portion 18 with the pressure chamber 12 to supply ink in the manifold 100 to the pressure chamber 12. Such a communicating plate 15 is made of, for example, a silicon substrate.

The nozzle plate 20 is joined to a face of the communicating plate 15, the face being opposite the flow path forming substrate 10, that is, the face facing the +Z direction. The nozzle plate 20 has a plurality of nozzles 21 each of which communicates with the pressure chamber 12 via the nozzle communicating passage 16. In the present embodiment, a plurality of nozzles 21 is disposed in line along the X axis direction for each pressure chamber row. In other words, in the present embodiment, two nozzle rows of nozzles 21 provided along the X axis direction are spaced apart in the Y axis direction. Each of the nozzles 21 constituting the two rows of nozzles is disposed to be at the same position in the X axis direction. Of course, when the two rows of pressure chambers are disposed half the pitch of pressure chambers 12 offset from each other in the X axis direction, the two rows of nozzles may be also disposed half the pitch of nozzles 21 offset from each other in the X axis direction. In other words, all nozzles 21 in the two rows of nozzles may be staggered along the X axis direction.

The nozzle plate 20 is made of, for example, a silicon substrate. The face, of the nozzle plate 20, facing the +Z direction constitutes part of the ejection face of the liquid ejecting head H.

The vibration plate 50, in the present embodiment, includes an elastic film 51, made of silicon oxide, provided at the flow path forming substrate 10, and an insulator film 52, made of zirconium oxide, provided at the face, of the elastic film 51, facing the −Z direction. The vibration plate 50 may have a configuration including only the elastic film 51, may have a configuration including only the insulator film 52, or may have a configuration including another film in addition to the elastic film 51 and the insulator film 52.

The piezoelectric actuator 300 includes a first electrode 60, a piezoelectric body layer 70, and a second electrode 80 that are sequentially stacked on the vibration plate 50 in the −Z direction. The piezoelectric actuator 300, also referred to as a piezoelectric element, is a portion that includes the first electrode 60, the piezoelectric body layer 70, and the second electrode 80. The portion where piezoelectric distortion occurs in the piezoelectric body layer 70 when voltage is applied between the first electrode 60 and the second electrode 80 is referred to as an active portion 310. In other words, the active portion 310 is a portion, of the piezoelectric body layer 70, sandwiched between the first electrode 60 and the second electrode 80. In the present embodiment, the active portion 310 are formed for each pressure chamber 12. Each of the plurality of active portions 310 is a “drive element” that produce a change in pressure of the ink in the pressure chamber 12. Generally, one of the electrodes of the active portion 310 is an individual electrode that is independent for each active portion 310, and the other electrode is a common electrode that is common to a plurality of active portions 310. In the present embodiment, the first electrode 60 is provided for each active portion 310 and constitutes an individual electrode of the active portion 310, and the second electrode 80 is provided continuously over the plurality of active portions 310 and constitutes a common electrode of the plurality of active portions 310. Of course, the first electrode 60 may constitute the common electrode and the second electrode 80 may constitute the individual electrode.

The piezoelectric body layer 70 is made of a piezoelectric material composed of, for example, a composite oxide with a perovskite structure, as represented by the general formula ABO₃.

An individual lead electrode 91, which is a lead wire, is drawn out from the first electrode 60. A common lead electrode, which is a lead wire (not shown), is drawn out from the second electrode 80. A flexible wiring board 110 is coupled to an end opposite the end, of each of the individual lead electrode 91 and the common lead electrode, coupled to the piezoelectric actuator 300. The wiring board 110 includes a drive circuit 111 having a plurality of switching elements that select whether to supply a drive signal (COM) for driving each of the active portion 310 to each active portion 310. In other words, the wiring board 110 in the present embodiment is a chip on film (COF). The wiring board 110 is not required to have the drive circuit 111. In other words, the wiring board 110 may include a flexible flat cable (FFC), a flexible printed circuits (FPC), or the like.

The protection substrate 30 having the substantially same size as the flow path forming substrate 10 is joined to the face, of the flow path forming substrate 10, facing the −Z direction. The protection substrate 30 includes a piezoelectric actuator accommodation portion 31, which is a space to protect the piezoelectric actuator 300. The piezoelectric actuator accommodation portion 31 is provided independently for each row of piezoelectric actuators 300 disposed side by side in the X axis direction, and is formed in two rows in the Y axis direction. The protection substrate 30 has a through hole 32 that passes through in the Z axis direction between two piezoelectric actuator accommodation portions 31 that are disposed side by side in the Y axis direction. The ends of the individual lead electrodes 91 drawn from the electrode of the piezoelectric actuator 300 and the common lead electrode (not shown) extend to be exposed in the through hole 32, and the individual lead electrodes 91 and the common lead electrodes are electrically coupled to the wiring board 110 in the through hole 32. The protection substrate 30 includes, for example, a silicon substrate as in the flow path forming substrate 10.

The case member 40 that defines part of the manifold 100 that communicates with the plurality of pressure chambers 12 is fixed to the protection substrate 30. The case member 40 has the substantially same shape as the communicating plate 15 described above in plan view, and is joined to the protection substrate 30 and also to the communicating plate 15 described above. The case member 40 has a recess 41, at the protection substrate 30, that is deep enough to accommodate the flow path forming substrate 10 and the protection substrate 30. The case member 40 includes a third manifold portion 42 that communicates with the first manifold portion 17 of the communicating plate 15. The first manifold portion 17 and the second manifold portion 18 of the communicating plate 15 and the third manifold portion 42 of the case member 40 constitute the manifold 100 in the present embodiment. The manifold 100 is provided for each row of nozzles. In other words, respective nozzle rows can eject different types of ink. The case member 40 has an introduction port 44 that communicates with the manifolds 100 to supply ink to each manifold 100. The case member 40 has a communication port 43 through which the wiring board 110 is inserted in communication with the through hole 32 of the protection substrate 30, and the wiring board 110 is led out, through the communication port 43, to the face, of the liquid ejecting head H, facing the −Z direction. The case member 40 is made of, for example, a metal material or a resin material.

A compliance substrate 45 is provided at the +Z direction side face, of the communicating plate 15, where the first manifold portion 17 and the second manifold portion 18 is open. The compliance substrate 45 seals the +Z direction side openings of the first manifold portion 17 and the second manifold portion 18. The compliance substrate 45, in the present embodiment, includes a sealing film 46 made of a flexible thin film and a fixed substrate 47 made of a rigid material such as metal. The region, of the fixed substrate 47, facing the manifold 100 has an opening 48 completely removed in the thickness direction, and one face of the manifold 100 is a compliance portion 49, which is a flexible portion that is sealed only by the sealing film 46 having flexibility.

In such a liquid ejecting head H, the liquid is taken in through the introduction port 44 and fills the inside of the flow path with ink from the manifold 100 to the nozzle 21. Thereafter, the vibration plate 50 together with the piezoelectric actuator 300 is deflected and deformed by applying a voltage to each active portion 310 corresponding to the pressure chamber 12 according to the signal from the drive circuit 111. This increases the pressure of the liquid in the pressure chamber 12 and ejects droplets from the predetermined nozzle 21.

The head chip Hc has a shape that is long in the X axis direction and short in the Y axis direction, toward the direction of the alignment of the nozzles 21.

The holder 130 includes a holder body 140 and a reinforcement plate 150 fixed to the face, of the holder body 140, facing +Z direction.

The holder body 140 is made of a material such as metal or resin. The holder body 140 has a first recess 141 having a recessed shape that opens to a face facing the +Z direction. The first recess 141 of the holder body 140 is defined by a first wall 142.

The reinforcement plate 150 and the cover 160 are fixed to the face, of the first wall 142 of the holder body 140, facing +Z direction. Specifically, a cover accommodation portion 143 having a recessed shape to which the reinforcement plate 150 and the cover 160 are fixed is provided at the face, of the first wall 142 of the holder body 140, facing the +Z direction. That is, the outer edge of the face, of the holder body 140, facing the +Z direction is an edge 144 protruding toward the +Z direction, and the edge 144 forms the cover accommodation portion 143. The reinforcement plate 150 is fixed to the bottom of the cover accommodation portion 143, that is, the face, of the first wall 142, facing the +Z direction, and the cover 160 is fixed to the face, of the reinforcement plate 150, facing the +Z direction. In the present embodiment, the holder body 140, the reinforcement plate 150, and the cover 160 are bonded together, for example, by an adhesive.

The reinforcement plate 150 is made of a plate member such as stainless steel or other metal. The reinforcement plate 150 has an opening 151 that communicates with the first recess 141. The opening 151 of the reinforcement plate 150 is defined by a second wall 152. In other words, the opening 151 is disposed at a position where the opening 151 overlaps the first recess 141 of the holder body 140 when viewed in the Z axis direction. The opening area of the opening 151 has the substantially same size as the first recess 141.

The holder 130 including the holder body 140 and the reinforcement plate 150 has an accommodation portion 131 having a recessed shape that opens to the +Z direction with the first recess 141 and the opening 151. That is, the first wall 142 of the holder body 140 defining the first recess 141 and the second wall 152 of the reinforcement plate 150 defining the opening 151 constitute a wall 132 defining the accommodation portion 131.

The accommodation portion 131 of the holder 130 accommodates the plurality of head chips Hc fixed to the cover 160. The opening of the accommodation portion 131 is sealed by the cover 160. In other words, the head chip Hc is accommodated in the space defined by the accommodation portion 131 and the cover 160. The accommodation portion 131 may be provided for each head chip Hc, or it may be provided continuously over the plurality of head chips Hc. In the present embodiment, the accommodation portion 131 is provided for each head chip Hc.

In the holder 130, the head chips Hc are disposed in a staggered pattern along the X axis direction. Here, the staggered arrangement of the head chips Hc along the X axis direction means that the head chips Hc disposed side by side in the X axis direction are alternately staggered in the Y axis direction. That is, two rows of head chips Hc disposed side by side in the X axis direction are disposed side by side in the Y axis direction, and the two rows of head chips Hc are staggered in the X axis direction. The staggered arrangement of the head chips Hc along the X axis direction allows the nozzles 21 of the two head chips Hc to partially overlap in the X axis direction, forming a continuous row of nozzles 21 over the X axis direction. By forming a long nozzle row over the X axis direction with the plurality of head chips Hc in this way, the yield can be improved and the cost can be reduced, compared with forming a long nozzle row in one head chip Hc. The number of head chips Hc held by the holder 130 is not limited to four, but may be one or more than two.

The cover 160 is made of a plate member such as stainless steel or other metal. The cover 160 has an exposed opening 161 that exposes the nozzle face with a plurality of nozzles 21 of each head chip Hc. The exposed opening 161 is provided independently for each head chip Hc in the present embodiment. The exposed opening 161 has a shape that is long in the X axis direction and short in the Y axis direction when viewed in the Z axis direction to match the shape of the head chip Hc.

The cover 160 has a first face 162 facing the +Z direction and a second face 163 opposite the first face 162, that is, facing the −Z direction. The cover 160 is then fixed to the nozzle face of the head chip Hc, that is, the face facing the +Z direction at the periphery of the exposed opening 161 of the second face 163. In the present embodiment, the cover 160 is joined to the fixed substrate 47 of the compliance substrate 45 of the head chip Hc. The first face 162 of the cover 160, together with the face, of the nozzle plate 20, facing +Z direction, constitutes the ejection face.

Such a cover 160 is fixed to the face, of the wall 132 of the holder 130, facing +Z direction so as to block the opening of the accommodation portion 131 of the holder 130. In the present embodiment, the cover 160 is fixed via the reinforcement plate 150 in the cover accommodation portion of the holder body 140.

The cover 160 has a thickness in the Z axis direction of 300 μm or less, preferably 200 μm or less, and more preferably 100 μm or less. By reducing the thickness of the cover 160 in the Z axis direction, the distance between the nozzle face where the nozzle 21 of the head chip Hc opens and the medium S, the so-called paper gap, can be shortened to improve the accuracy of landing of droplets ejected from the head chip Hc on the medium.

The reinforcement plate 150 is preferably made of a material that is stronger than the cover 160. In the present embodiment, the reinforcement plate 150 is made of a plate member of the material same as that of the cover 160 and thicker in the Z axis direction than the cover 160. Of course, the reinforcement plate 150 may be made of a material different from that of the cover 160.

The reinforcement plate 150 has a through hole 153 at a position different than that of the opening 151. Here, the fact that the through hole 153 is located at a position different from that of the opening 151 means that the opening 151 and the through hole 153 do not communicated with each other. In the present embodiment, each through hole 153 is provided between two openings 151 disposed side by side in the X axis direction when viewed in the Z axis direction. In other words, the reinforcement plate 150 has two through holes 153. A temperature detection element (not shown) that detects the temperature of the cover 160 is directed into the through hole 153 of the reinforcement plate 150. Of course, the temperature detection element may not be provided in the through hole 153, or the through hole 153 may not be provided.

The liquid ejecting head H includes a detection element 200 that detects a deformation of the cover 160. The detection element 200 is disposed at the second face 163 of the cover 160 in the present embodiment. In other words, the detection element 200 includes a strain gauge fixed to the second face 163, of the cover 160, facing the −Z direction to detect the deformation of the cover 160. The strain gauge is a conductive resistive element that is attached to an object to be measured and measures the amount of strain in a plurality of steps according to the electrical resistance value that changes in proportion to the expansion and contraction of the object to be measured. The electrical resistance value detected by the strain gauge is detected as, for example, a voltage value. Deformation of the cover 160 can be detected by using the strain gauge as the detection element 200. When the strain gauge is used as the detection element 200, the larger the strain of the detection element 200, the higher the voltage output from the detection element 200, so that the amount of deformation of the cover 160 can be detected by the magnitude of the voltage output from the detection element 200.

At least part of the detection element 200 is disposed at a position outside a first region 164 where the wall 132 of the cover 160 is fixed. The cover 160 includes the first region 164 to which the wall 132 is fixed, the second region 165 to which the head chip Hc is fixed, and a third region 166 between the first region 164 and the second region 165. The detection element 200 is disposed in the third region 166 of the cover 160 along the X axis, the longitudinal direction of the head chip Hc, as shown in FIGS. 7 and 8. The third region 166 faces the accommodation portion 131 in the Z axis direction. Therefore, the detection element 200 formed in the third region 166 is disposed in the accommodation portion 131. In the present embodiment, the detection element 200 is electrically independent for each head chip Hc. In other words, in the present embodiment, since the accommodation portion 131 is provided independently for each head chip Hc, a total of four detection elements 200 are provided for each accommodation portion 131.

The detection element 200 is formed in the third region 166 of the second face 163 in a so-called U-shape that is formed by coupling one ends of two straight portions that are straight along the X axis direction. The length of the detection element 200 along the X axis direction is longer than the head chip Hc in the present embodiment. Of course, the length of the detection element 200 along the X axis direction may be shorter than the head chip Hc. The detection element 200 may be provided in a zigzag meandering manner, that is, may extend in the X axis direction and meander in the Y axis direction. By providing the detection element 200 in a meandering manner, the detection element 200 can be formed longer and the detection element 200 can be formed with a higher resistance value. Therefore, the detection element 200 can be used as a strain gauge that is sensitive to the deformation of the cover 160.

Here, the second region 165 of the cover 160 is a region fixed to the head chip Hc, and the first region 164 is a region fixed to the wall 132. Therefore, the first region 164 and the second region 165 are difficult to deform because they are supported by the wall 132 and head chip Hc at the second face 163. In contrast, the third region 166 is more easily deformed than the first region 164 and the second region 165, because, in the third region 166 of the cover 160, neither the first face 162 nor the second face 163 is fixed to any other member. By providing the detection element 200 in the third region 166 where the cover 160 is easily deformed, the detection element 200 can improve the accuracy of detection of the deformation of the cover 160.

All of the detection elements 200 in the present embodiment are provided in the third region 166. At least part of the detection element 200 is only required to be provided in the third region 166, and the remaining part may be provided in the first region 164, the second region 165, and the like.

Each of the detection elements 200 can detect the deformation of the cover 160 around the head chip Hc. The head chip Hc is prone to cause misalignment of landing of droplets ejected from the head chip Hc on the medium S due to a stress along the X axis direction, which is the longitudinal direction. Therefore, by providing the detection element 200 along the X axis direction, which is the longitudinal direction of the head chip Hc, the deformation of the cover 160 in the X axis direction can be detected with high accuracy, and it is easy to detect misalignment of landing of droplets ejected from the head chip Hc due to the stress caused by the deformation of the cover 160 along the X axis direction. By providing the detection element 200 electrically independent for each head chip Hc, it is possible to grasp which of the four head chips Hc has an anomaly by the detection by respective detection elements 200. Therefore, it is possible to so-called refurbish the product such as identifying and replacing a head chip Hc that has an anomaly, or manufacturing a new liquid ejecting head H by reusing a head chip Hc that does not have an anomaly.

By providing the liquid ejecting head H with the detection element 200 that detects a deformation of the cover 160, the deformation of the cover 160 can be easily detected and an anomaly of the liquid ejecting head H due to deformation of the cover 160 can be detected.

The detection element 200 can be disposed at the cover 160 to allow the detection element 200 to directly detect the deformation of the cover 160, thereby improving the accuracy of detection by the detection element 200. In addition, by disposing the detection element 200 on the second face 163 of the cover 160, the paper gap between the ejection face and the medium S is prevented from becoming large, compared with the paper gap when the detection element 200 is provided at the first face 162, and destruction of the detection element 200 and deformation of the cover 160 when the medium S collides with the detection element 200 can be suppressed.

The cover 160 is generally grounded to release static electricity from the medium S. Therefore, the second face 163 of the cover 160 at which the detection element 200 is disposed is preferably insulated. The insulation process can be performed, for example, by applying a surface treatment to the second face 163 with a fluoroplastic or the like, or by fixing a film that is an insulator to the second face 163 by an adhesive. Alternatively, the detection element 200 is preferably bonded to the second face 163 by an insulating adhesive. Disposing the detection element 200 at the insulating film fixed to the second face 163, in other words, disposing the detection element 200 at the second face 163 through the film, is synonymous with disposing the detection element 200 at the second face 163 of the cover 160.

Here, deformation of the cover 160 of the liquid ejecting head H is caused by various factors as follows.

For example, deformation of the cover 160 may be caused by stress during assembly of the liquid ejecting head H, specifically when fixing the head chip Hc to the cover 160 or when fixing the cover 160 with the head chip Hc assembled to the holder 130. Deformation of the cover 160 may be caused when assembling the assembled liquid ejecting head H into the liquid ejecting apparatus 1.

Deformation of the cover 160 may be caused by the medium S colliding with the cover 160 during printing or the like.

Deformation of the cover 160 may be caused by deformation of the holder 130 due to linear expansion caused by the heat generated by using the liquid ejecting head H.

When the cover 160 is deformed in this manner, stress may be generated at the joining portion between the head chip Hc and the cover 160, and the compliance portion 49 may not function properly.

When the cover 160 is deformed, the communicating plate 15 of the head chip Hc may be damaged and ink may leak from the communicating plate 15.

When the introduction port 44 that communicates with the flow path is provided at both ends of the head chip Hc in the X axis direction, which is the longitudinal direction of the head chip Hc, deformation of the cover 160 may cause the head chip Hc to tilt and deform in the longitudinal direction, thereby causing ink to leak from the introduction port 44.

When suction cleaning in which the ejection face of the liquid ejecting head H is covered with a cap and the liquid in the liquid ejecting head H is suctioned and discharged through the cap by suction unit is performed, in a case where the cover 160 is deformed, capping failure by the cap may occur, and suction cleaning and moisturizing by the moisture retaining cap may not be carried out properly, resulting in thickening of the liquid in the nozzle 21.

When the plurality of head chips Hc is positioned with the cover 160, in a case where the cover 160 is deformed, the head chips Hc may be misaligned with each other, resulting in misalignment of landing of droplets on the medium S.

Therefore, by detecting the deformation of the cover 160 with the detection element 200, the above-mentioned anomaly that occurs in the liquid ejecting head H can be easily detected.

Detection element wiring 203 is coupled to each of the both ends of the detection element 200. The detection element wiring 203 is part of the “relay wiring coupled to the detection element”. In the present embodiment, the both ends of the detection element 200 are disposed in the accommodation portion 131. Therefore, the detection element wiring 203 is coupled to the detection element 200 in the accommodation portion 131. The detection element wiring 203 in the present embodiment includes a flexible wiring board, such as an FPC. Of course, the detection element 200 with the detection element wiring 203 may not be coupled in the accommodation portion 131, but may be coupled in the first region 164 or in the second region 165, or the detection element 200 may be extended to the outside of the first region 164 and may be coupled to the detection element wiring 203 outside of the first region 164.

The holder 130 has a plurality of communicating passages 135 through which the ink is distributed between the head chip Hc and the flow path member 170. The communicating passage 135 opens to the bottom of the accommodation portion 131 at one end, that is, to a face facing the −Z direction in the accommodation portion 131, and is coupled to each of the four introduction ports 44 of the head chip Hc. Therefore, the four communicating passages 135 are provided for one head chip Hc. The other end of the communicating passage 135 opens to the face, of the holder 130, facing −Z direction and is coupled to the flow path of the flow path member 170, which will be described in detail later.

The holder 130 has a wiring insertion hole 136 through which the wiring board 110 and the detection element wiring 203 of the head chip Hc are inserted for each of the accommodation portions 131. The wiring insertion hole 136 is provided open to the bottom of the accommodation portion 131, that is, open to the −Z direction side face in the accommodation portion 131 and is provided open to the −Z direction side face of the holder 130.

The flow path member 170 is fixed to the face, of the holder 130, facing −Z direction. The flow path member 170 is composed of a plurality of members stacked in the Z axis direction. The flow path that supplies a liquid to the head chip Hc is provided inside (not shown) the flow path member 170. Two flow path communication portions 171 that communicate with the internal flow paths are provided at the face, of the flow path member 170, facing −Z direction. The liquid from the liquid reservoir 3 is supplied from the flow path communication portion 171 via a supply tube (not shown) or the like provided outside the liquid ejecting head H.

The relay board 180, as shown in FIGS. 3 and 6, includes a first relay board 181, a second relay board 182, and a third relay board 183 that couples the first relay board 181 with the second relay board 182.

The first relay board 181 is made of a rigid board with no flexibility on which the wiring, the electronic components and the like (not shown) are mounted. In the present embodiment, as an example of an electronic component an external connector 184 to which the external wiring (not shown) provided outside the liquid ejecting head H is coupled is illustrated. The first relay board 181 is fixed to the face, of the flow path member 170, facing −Z direction.

The second relay board 182 is made of a rigid board with no flexibility on which are mounted the wiring, the electronic components, and the like (not shown). In the present embodiment, a first connector 185 and a second connector 186 are illustrated as an example of the electronic component, as shown in FIGS. 3 and 6. The wiring board 110 of the head chip Hc is coupled to the first connector 185, and the detection element wiring 203 is coupled to the second connector 186.

The second relay board 182 is fixed to each of the both faces, of the flow path member 170, in the Y axis direction. In other words, one liquid ejecting head H has two second relay boards 182. The second relay board 182 disposed in the +Y direction of the flow path member 170 is commonly coupled to the wiring board 110 and the detection element wiring 203 of the two head chips Hc disposed in the +Y direction. The second relay board 182 disposed in the −Y direction of the flow path member 170 is commonly coupled to the wiring board 110 and the detection element wiring 203 of the two head chips Hc disposed in the −Y direction.

The first relay board 181 and the two second relay boards 182 are coupled via the third relay board 183. The third relay board 183 is made of, for example, a flexible wiring board with flexibility.

Drive signals, head control signals, and the like for controlling the head chip Hc are input from the external wiring to the first relay board 181 via the external connector 184. Various signals input to the first relay board 181 are input to the two second relay boards 182 via the third relay board 183, and input to each head chip He from the second relay board 182. In other words, the wiring (not shown) for the drive signals is provided at the relay board 180 and the wiring board 110 of each head chip Hc. The voltage detected by the detection element 200 is transmitted to the outside via the external wiring from the external connector 184 via the detection element wiring 203 and the wiring (not shown) of the relay board 180. The wiring (not shown) of the relay board 180 that is electrically coupled to the detection element wiring 203 is the remainder of the “relay wiring coupled to the detection element”.

In other words, the external connector 184 has a terminal coupled to the detection element wiring 203 coupled to the detection element 200 and the wiring (not shown) of the relay board 180 coupled to the detection element wiring 203, and a terminal coupled to the wiring board 110 to which the drive signal for driving the active portion 310 for ejecting a liquid is input and the wiring (not shown) of relay board 180 coupled to the wiring board 110. This eliminates the need for providing a connector for inputting the drive signal for driving the active portion 310 of the liquid ejecting head H from the outside and a connector for outputting the voltage output by the detection element 200 separately, and the common external connector 184 can be used for coupling, thereby reducing costs. Of course, a connector for inputting the drive signal for driving the active portion 310 of the liquid ejecting head H from the outside and a connector for outputting the voltage output by the detection element 200 may be provided separately. The relay board for inputting the drive signal to the active portion 310 and the relay board for outputting the voltage output by the detection element 200 may be provided separately.

The signal amplification circuit and the digital circuit required for the detection element 200 to detect the deformation of the cover 160 may be provided, for example, in the relay board 180, or in the control unit 4 or the like that is coupled via the external wiring of the liquid ejecting head H.

Furthermore, the cover member 190 is fixed to the face, of the holder 130, facing −Z direction and accommodates the flow path member 170 and relay board 180 therein.

The cover member 190 has an electrical coupling opening 191 that open to the face facing the −Z direction. The external connector 184 of the relay board 180, which is accommodated inside the cover member 190, is exposed to the outside via the electrical coupling opening 191.

The cover member 190 has two flow path communication openings 192 at the face facing the −Z direction. The flow path communication portion 171 of the flow path member 170, which is accommodated inside the cover member 190, is exposed to the outside via the flow path communication opening 192.

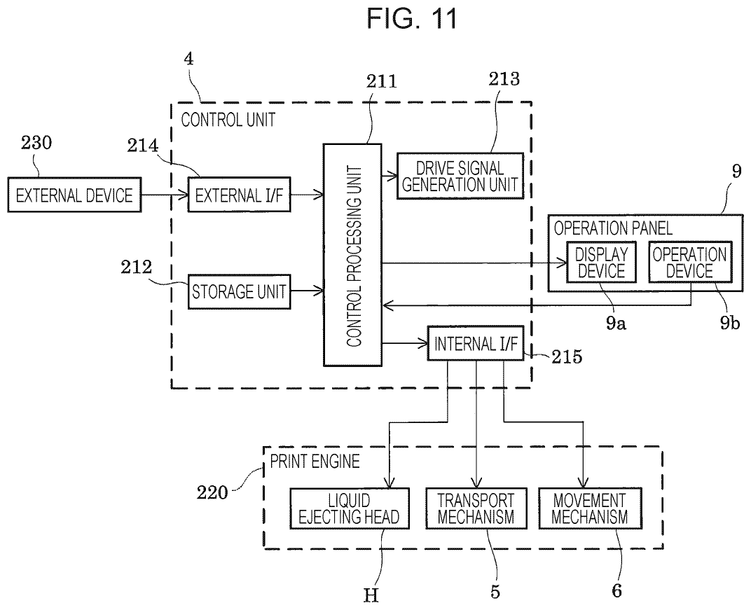

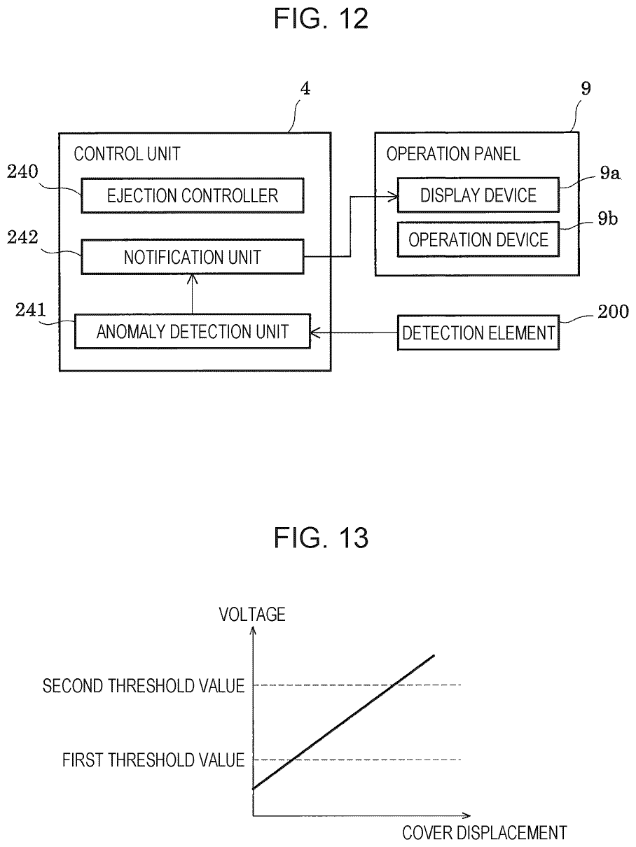

The electrical configuration of the liquid ejecting apparatus 1 in the present embodiment is described with reference to FIGS. 11 and 12. FIG. 11 is a block diagram showing the electrical configuration of the liquid ejecting apparatus 1 of the present embodiment. FIG. 12 is a block diagram showing the function implementing unit of the control unit 4.

As shown in FIG. 11, the liquid ejecting apparatus 1 includes the control unit 4 that is a controller of the present embodiment, a print engine 220, and the operation panel 9.

The control unit 4 is the element that controls the entire liquid ejecting apparatus 1. The control unit 4 includes a control processing unit 211 that includes a CPU and other components, a storage unit 212, a drive signal generation unit 213, an external interface (I/F) 214, and an internal I/F 215. The storage unit 212 includes a ROM that records a control program and the like, and a RAM that temporarily records various pieces of data required for printing images. The control processing unit 211 comprehensively controls respective components of the liquid ejecting apparatus 1 by executing the control program recorded in the storage unit 212.

Print data indicating the image to be printed on the medium S is transmitted from an external device 230 such as a host computer to the external I/F 214 of the control unit 4, and the print engine 220 is coupled to the internal I/F 215. The print engine 220 is a component that records the image on the medium S under control by the control unit 4 and includes the liquid ejecting head H, the transport mechanism 5, and the movement mechanism 6.

As shown in FIG. 12, the control unit 4 has the functions of an ejection controller 240, an anomaly detection unit 241, and a notification unit 242.

The ejection controller 240 controls the ejection of droplets from the nozzles 21 of the liquid ejecting head H. Specifically, the control processing unit 211 converts the print data transmitted from the external device 230 to the external I/F 214 into head control signals that instruct each drive element to eject/non-eject droplets from each nozzle 21 of the liquid ejecting head H, such as a clock signal CLK, a latch signal LAT, a change signal CH, pixel data SI, setting data SP, and the like, to transmit the signals to the liquid ejecting head H via the internal I/F 215. The drive signal generation unit 213 generates a drive signal (COM) and transmits the signal to the liquid ejecting head H via the internal I/F 215. In other words, ejection data such as the head control data and the drive signals are transmitted to the liquid ejecting head H via the internal I/F 215, which is the transmission unit.

The liquid ejecting head H to which ejection data such as the head control signal and the drive signal are supplied by the control unit 4 generates applied pulses from the head control signal and the drive signal, and applies the applied pulses to the drive element.

The control processing unit 211 generates control signals for movement of the transport mechanism 5 and the movement mechanism 6 from the print data received from the external device 230 via the external I/F 214, and transmits the control signals to the transport mechanism 5 and the movement mechanism 6 via the internal I/F 215 to control the transport mechanism 5 and the movement mechanism 6. This performs printing on the medium S.

The anomaly detection unit 241 detects an anomaly of the liquid ejecting head H due to deformation of the cover 160 based on the voltage output from the detection element 200. In other words, the anomaly detection unit 241 determines the degree of deformation of the cover 160 by comparing the voltage (hereinafter referred to as an initial value) detected by the detection element 200 before the deformation of the cover 160 and the voltage detected by the detection element 200 after the deformation of the cover 160. The voltage output from the detection element 200 is an example of a “detection signal”.

The initial value may, for example, be the result of measurement after the liquid ejecting head H is manufactured and before the liquid ejecting head H is shipped from the factory, that is, before the liquid ejecting head H is attached to the holding body 7 of the liquid ejecting apparatus 1. The measured initial value is preferably stored in a storage cell (not shown) included in the liquid ejecting head H prior to the factory shipment of the liquid ejecting head H, for example, in a storage cell built into the drive circuit 111 included in the wiring board 110. Of course, when the liquid ejecting head H includes a storage cell other than the drive circuit 111, the initial value may be stored in the storage cell. This allows the anomaly detection unit 241 to read the initial value with the liquid ejecting head H attached to the liquid ejecting apparatus 1. In this configuration, even when the liquid ejecting head H is replaced, the initial value of the new liquid ejecting head H can be easily read out. The initial value may be stored in a storage cell (not shown) in the control unit 4 of the liquid ejecting apparatus 1. The deformation of the cover 160 due to a stress when the liquid ejecting head H is attached to the holding body 7 of the liquid ejecting apparatus 1 can be detected by comparing the initial value as the value detected by the detection element 200 before the liquid ejecting head H is attached to the holding body 7 of the liquid ejecting apparatus 1 and the value measured after the liquid ejecting head H is attached to the holding body 7. The value measured after the attachment is preferably a value measured before the liquid ejecting head H starts the first printing operation.

The initial value may, for example, be the result of measurement after the liquid ejecting head H is attached to the holding body 7 of the liquid ejecting apparatus 1. When the initial value is measured, it is assumed that the cover 160 is not deformed when the liquid ejecting head H is attached to the holding body 7 of the liquid ejecting apparatus 1. It is preferable to measure the initial value after the liquid ejecting head H is attached to the holding body 7 of the liquid ejecting apparatus 1, but before the liquid ejecting head H starts the first printing operation.

The anomaly detection unit 241 can detect the amount of deformation of the cover 160 by comparing the initial value measured in advance with the voltage output from the detection element 200. When the voltage detected by the detection element 200 is less than or equal to the preset threshold value, the anomaly detection unit 241 determines that the deformation of the cover 160 stays in the range in which no anomaly occurs in the liquid ejecting head H. When the voltage detected by the detection element 200 is greater than a preset threshold value, the anomaly detection unit 241 determines that an anomaly has occurred in the liquid ejecting head H due to deformation of the cover 160. The threshold value to be determined by the anomaly detection unit 241 can be set in advance by experiment, simulation, or the like. As in the initial value described above, the threshold value can be stored in a storage cell, or the like built into the drive circuit 111.

The notification unit 242 notifies the user of an anomaly of the liquid ejecting head H detected by the anomaly detection unit 241. In the present embodiment, the notification unit 242 notifies the user of an anomaly of the liquid ejecting head H by displaying the anomaly on the display device 9a. For example, when the voltage output by the detection element 200 is below the threshold value as described above and it is determined that the liquid ejecting head H has no anomaly due to deformation of the cover 160, the notification unit 242 displays nothing in particular on the display device 9a, or indicates that the liquid ejecting head H has no anomaly.

When the anomaly detection unit 241 detects an anomaly, the notification unit 242 displays on the display device 9a that an anomaly has occurred in the liquid ejecting head H. In the present embodiment, when the voltage output by any of the four detection elements 200 exceeds the threshold value, the anomaly detection unit 241 can determine that an anomaly has occurred in the head chip Hc corresponding to the detection element 200 that detects a voltage exceeding the threshold value. Therefore, the notification unit 242 may display, on the display device 9a, information about which of the plurality of head chips Hc has an anomaly. Specifically, when the detection element 200 is electrically independent for each head chip Hc as in the present embodiment, it is possible to identify that an anomaly has occurred in the head chip Hc corresponding to the detection element 200 that has detected a voltage exceeding the threshold value, so that it is sufficient to display, on the display device 9a, the location of the head chip Hc in which the error occurred. In other words, “that an anomaly has occurred in the liquid ejecting head H” may include information about which of the plurality of head chips Hc has the anomaly. When displaying on the display device 9a that an anomaly has occurred in the liquid ejecting head H, the notification unit 242 may, for example, display a message urging the replacement of a specific head chip Hc or the liquid ejecting head H. In other words, “that an anomaly has occurred in the liquid ejecting head H” may include information encouraging the replacement of the liquid ejecting head H.

The user who is notified of an anomaly of the liquid ejecting head H by the notification unit 242 can immediately replace the liquid ejecting head H or a specific head chip Hc by themselves or request a maintenance contractor such as the manufacturer of the liquid ejecting head H to replace the failed liquid ejecting head H or specific head chip Hc, or take other measures.

The method of notifying the user of the anomaly of the liquid ejecting head H by the notification unit 242 is not limited to the display on the display device 9a. The notification unit 242 may, for example, make a notification using an audio generation unit that emits an alarm sound or a voice, or make a notification by blinking or lighting a white light such as an LED lamp. The notification unit 242 may output, to the external device 230 such as a host computer, a signal for making a notification of an anomaly of the liquid ejecting head H.

In the example described above, the anomaly detection unit 241 uses one threshold value to make a decision, but the present disclosure is not particularly limited to this. The anomaly detection unit 241 may, for example, detect an anomaly of the liquid ejecting head H with a preset first threshold value and a second threshold value larger than the first threshold value, as shown in FIG. 13. For example, when the voltage output by the detection element 200 is below the first threshold value, the anomaly detection unit 241 determines that no anomaly has occurred in the liquid ejecting head H due to deformation of the cover 160.

When the voltage output by the detection element 200 is greater than the first threshold value and equal to or less than the second threshold value, the anomaly detection unit 241 determines that the head chip Hc has not failed, but the cover 160 is deformed to the extent that a printing defect occurs.

When the voltage output by the detection element 200 is greater than the second threshold value, the anomaly detection unit 241 determines that the head chip Hc has failed, for example, that the cover 160 is deformed to the extent that the communicating plate 15 is cracked.

When the voltage output by the detection element 200 is below the first threshold value and the anomaly detection unit 241 determines that there is no anomaly in the liquid ejecting head H, the notification unit 242 displays nothing in particular on the display device 9a or indicates that there is no anomaly in the liquid ejecting head H.

When the voltage detected by the detection element 200 is greater than the first threshold value and equal to or less than the second threshold value, and the anomaly detection unit 241 determines that the cover 160 is deformed to the extent that the head chip Hc has not failed, the notification unit 242 displays on the display device 9a that an anomaly has occurred in the liquid ejecting head H and that the head chip Hc can be reused, but the cover 160 cannot be reused. In other words, even in a case where the cover 160 is deformed, when the deformation is minute, no significant stress is applied to each of the components of the head chip Hc, and cracks or poor adhesion between components may not occur in the components of the head chip Hc. When the cover 160 is deformed in this way, but the head chip Hc is normal, it is possible to so-called refurbish the product such as replacing only the cover 160, or manufacturing a new liquid ejecting head H by reusing a head chip Hc that has not failed.

When the detection element 200 detects that the voltage detected is greater than the second threshold value and the anomaly detection unit 241 determines that the cover 160 is deformed to the extent that the head chip Hc has failed, the notification unit 242 displays on the display device 9a that an anomaly has occurred in the liquid ejecting head H and that the head chip Hc and the cover 160 cannot be reused.

In this way, the first threshold value and the second threshold value are provided in advance according to the state of deformation of the cover 160, and the anomaly detection unit 241 determines the degree of deformation of the cover 160 based on the first threshold value and the second threshold value and makes a notification, so that the user can take action according to the degree of deformation of the cover 160. The first threshold value may correspond to the degree of deformation of the cover 160 corresponding to a state just before a printing defect actually occurs. Similarly, the first threshold value may correspond to the degree of deformation of the cover 160 corresponding to a state just before the head chip Hc actually fails. This allows the user to be notified of the information before a printing defect occurs or before the head chip Hc fails, thereby suppressing the occurrence of a printing defects and preventing the head chip Hc from failing.

Detection of an anomaly of the liquid ejecting head H by the anomaly detection unit 241 may constantly monitor the voltage output from the detection element 200, but for example, by detecting an anomaly at various timings, the cause of deformation of the cover 160 can be identified.

As described above, measurement before and after the attachment of the liquid ejecting head H to the holding body 7 makes it possible to detect the deformation of the cover 160 during the attachment of the liquid ejecting head H.

For example, detecting an anomaly of the liquid ejecting head H immediately before or after the printing operation makes it possible to detect the deformation of the cover 160 caused by collision of the medium S.

Detecting the deformation of the cover 160 before sealing the ejection face of the liquid ejecting head H with a cap or a moisture retaining cap, before so called capping makes it possible to detect poor cleaning operation or poor moisture retention due to poor sealing during capping caused by deformation of the cover 160.

Detecting the deformation of the cover 160 after the cap or the moisture retaining cap is removed from the ejection face of the liquid ejecting head H after sealing the ejection face of the liquid ejecting head H with the cap or the moisture retaining cap, after so called uncapping makes it possible to detect the deformation of the cover 160 caused by the load due to the capping acting abnormally on the cover 160.

Furthermore, detecting the deformation of the cover 160 after wiping off liquid adhered to the ejection face with a wiper makes it possible to detect the deformation of the cover 160 caused by abnormal wiping by the wiper.

Detecting the deformation of the cover 160 at various times in this manner makes it possible to identify a cause of the deformation of the cover 160 and notify the user of the cause. Thus, the user can easily eliminate the defect that caused the cover 160 to deform and take measures to prevent the cover 160 from deforming again.

In the present embodiment, any of the four head chips Hc is an example of a “first head chip” and the detection element 200 corresponding to the first head chip is an example of a “first detection element”. The accommodation portion 131 in which the first head chip is accommodated is an example of a “first accommodation space”. Any of the four head chips Hc is an example of a “second head chip” and the detection element 200 corresponding to the second head chip is an example of a “second detection element”. The accommodation portion 131 in which the second head chip is accommodated is an example of a “second accommodation space”. The X axis direction is an example of the “longitudinal direction” of the head chip Hc.

### Second Embodiment

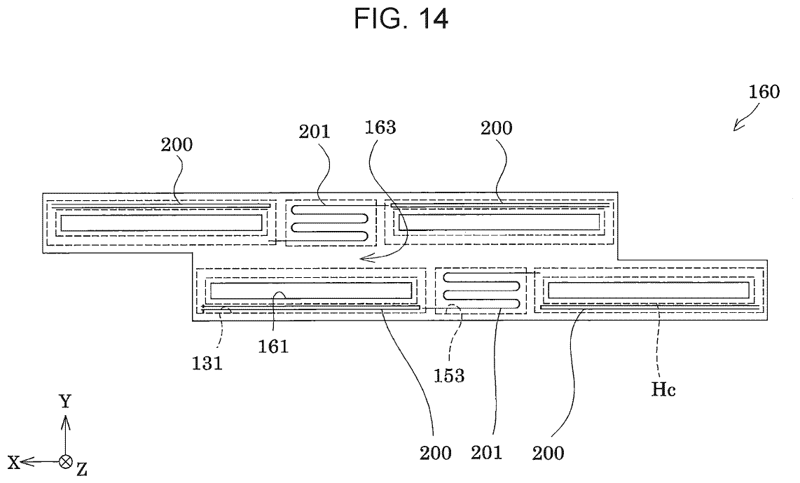

FIG. 14 is a plan view of the cover 160 of the liquid ejecting head H when viewing the +Z direction according to the second embodiment of the present disclosure. The same symbols are used for the same components as in the first embodiment above, and redundant descriptions are omitted.

As shown in FIG. 14, the liquid ejecting head H includes the detection element 200 and a detection element 201. Since the detection element 200 is the same as the detection element 200 of the first embodiment described above, the same symbol is used and redundant descriptions are omitted.

The detection element 201 includes a strain gauge provided in a region, of the second face 163 of the cover 160, facing the through hole 153. In the present embodiment, the detection element 201 is provided in the region, of the second face 163, facing the through hole 153 in a zigzag meandering manner along the surface of the second face 163. In other words, the detection element 201 is provided in a meandering manner in the Y axis direction while provided in a reciprocating manner in the X axis direction. The detection element 201 is electrically independent of the detection element 200. Therefore, one end of the detection element 201 is coupled to the detection element wiring (not shown) in one of the adjacent accommodation portions 131 in the X axis direction, and the other end of the detection element 201 is coupled to the detection element wiring (not shown) in the other of the adjacent accommodation portions 131 in the X axis direction. The detection element wiring coupled to the detection element 201 is coupled to the relay board 180, as in the detection element wiring 203 coupled to the detection element 200. The wall 142 of the holder body 140 may have a through hole that communicates with the through hole 153 at a position facing the through hole 153. In such a configuration, the detection element wiring coupled to the detection element 201 may be coupled to the relay board 180 via the through hole 153 and the through hole in the wall 142.

The detection element 200 can detect the deformation of the cover 160 around each head chip Hc. Therefore, it is possible to detect the above-mentioned anomaly of the liquid ejecting head H, especially the misalignment of landing of droplets ejected from each head chip Hc on the medium S due to deformation of the cover 160.

The detection element 201 can detect the deformation of the cover 160 between the two head chips Hc disposed side by side in the X axis direction. Therefore, it is possible to detect the anomaly of the liquid ejecting head H due to deformation of the cover 160 between the two head chips Hc disposed side by side in the X axis direction. In addition, in the present embodiment, by providing the detection element 201 in a meandering manner, the detection element 201 can be formed longer and the detection element 201 can be formed with a higher resistance value. Therefore, the detection element 201 can be used as a strain gauge that is sensitive to the deformation of the cover 160.

The detection element 201 together with the temperature detection element can be disposed in the through hole 153. Thus, by providing the temperature detection element and the detection element 201 in the through hole 153, the spaces for providing respective element are not required separately, and the liquid ejecting head H can be made compact.

In the present embodiment, any of the two detection elements 201 is an example of a “first detection element”.

In the present embodiment, any of the four head chips Hc is an example of a “first head chip” and the detection element 200 corresponding to the first head chip may be an example of the “first detection element”, in this case, the accommodation portion 131 in which the first head chip is accommodated is an example of a “first accommodation space” and any of the four head chip Hc is an example of a “second head chip”, the detection element 200 corresponding to a second head chip is an example of a “second detection element”, and the accommodation portion 131 in which the second head chip is accommodated is an example of a “second accommodation space”. The X axis direction is an example of the “longitudinal direction” of the head chip Hc.

Although the liquid ejecting head H in the present embodiment includes the detection element 200 and the detection element 201, the liquid ejecting head H may include only the detection element 201 without the detection element 200.

### Other Embodiments

Although respective embodiments of the present disclosure are described above, the basic structure of the present disclosure is not limited to those described above.

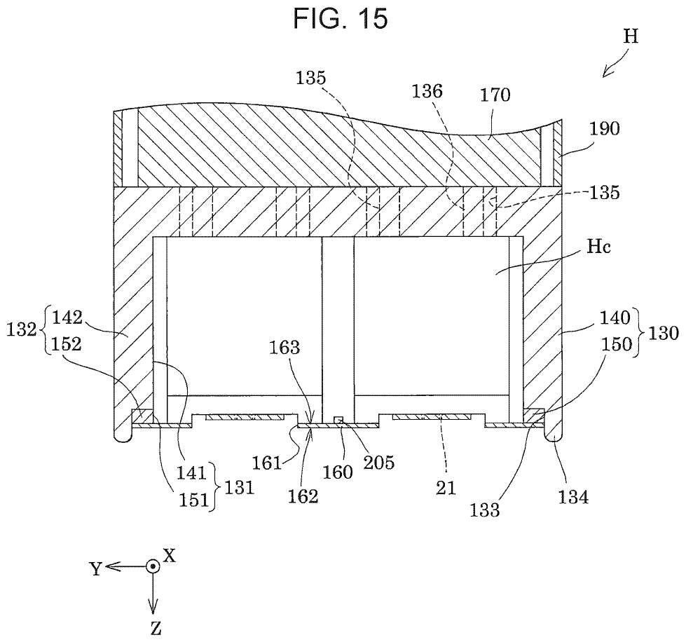

For example, the first embodiment described above illustrates a configuration in which the holder 130 includes the accommodation portion 131 independently for each head chip Hc, but the present disclosure is not particularly limited to this. Here, a modification of the liquid ejecting head H is shown in FIG. 15. FIG. 15 is a cross-sectional view of the main part of the modification of the liquid ejecting head H taken along line VIII-VIII in FIG. 5.

As shown in FIG. 15, the two head chips Hc are accommodated in the common accommodation portion 131. The accommodation portion 131 is defined by the wall 132. In the present embodiment, of the two head chips Hc, the head chip Hc disposed in the −Y direction is referred to as the first head chip and the head chip Hc disposed in the +Y direction is referred to as the second head chip.

One detection element 205 is disposed between the first head chip Hc and the second head chip Hc. In other words, the detection element 205 in the present embodiment is a common detection element that serves both as a detection element for the first head chip Hc that detects a deformation of the cover 160 around the first head chip Hc and a detection element for the second head chip Hc that detects the deformation of the cover 160 around the second head chip Hc. Providing one detection element 205 in common for two head chips Hc makes it possible to reduce the number of parts and lower costs, compared with providing a detection element for each head chip Hc, and reduce the space where the detection element 205 is disposed to make the liquid ejecting head H compact. Even when a plurality of head chips Hc is disposed in the common accommodation portion 131, the detection element 200 may be provided individually for each of the plurality of head chips Hc as in the first embodiment.

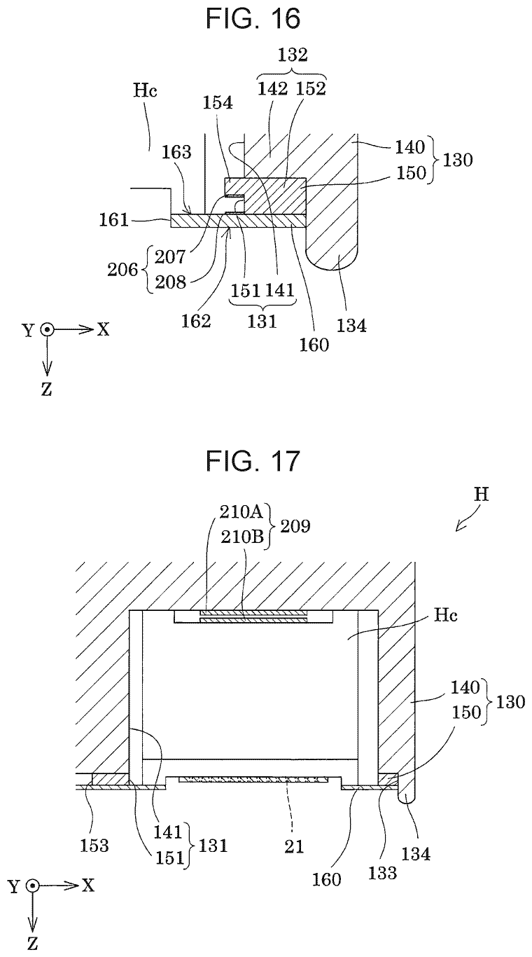

In each of the described above mentioned embodiments, the strain gauge is used as the detection element 200 and the detection element 201 to detect the deformation of the cover 160, but the present disclosure is not particularly limited to this. Here, a resistance film type pressure sensor may be used as the detection element. An example using a resistance film type pressure sensor as the detection element is shown in FIG. 16. FIG. 16 is an enlarged cross-sectional view of the main part of a modification of the liquid ejecting head H.

As shown in FIG. 16, the reinforcement plate 150 has a projection 154 protruding eaves-like into the opening 151. A space is defined between the face, of the projection 154, facing +Z direction and the cover 160.

The detection element 206 includes a resistance film type pressure sensor and includes an upper electrode 207 provided at the face, of the projection 154, facing +Z direction and a lower electrode 208 provided at a position facing the upper electrode 207 on the second face 163 of the cover 160.

In the detection element 206, as the cover 160 deforms, the distance between the upper electrode 207 and the lower electrode 208 shortens or lengthens, and the resistance value between the upper electrode 207 and the lower electrode 208 changes. The change in resistance value between the upper electrode 207 and the lower electrode 208 changes the output voltage between the upper electrode 207 and the lower electrode 208. Specifically, the closer the upper electrode 207 and the lower electrode 208 are, the more the contact area between them increases and the lower the resistance value, and thus the lower the voltage value output from the detection element 206. Therefore, the detection element 206 can detect the deformation of the cover 160 by detecting a change in the voltage between the upper electrode 207 and the lower electrode 208.

The detection element that detects a deformation of the cover 160 is not limited to a resistance film type pressure sensor, but may be, for example, a piezoelectric effect sensor or a capacitance type pressure sensor. Incidentally, a piezoelectric effect sensor is a sensor using a piezoelectric material that generates an electric charge on its face when pressure is applied. Since the magnitude of the electric charge is proportional to the applied force, the greater the amount of deformation, the greater the electric charge, or detected voltage. In addition, the capacitance type pressure sensor is a sensor in which the larger the deformation, the smaller the capacitance detected. For the capacitance type pressure sensor, the first threshold value may be larger than the second threshold value.

In the first embodiment described above, the detection element 200 is provided at the second face 163 of the cover 160, but the present disclosure is not particularly limited to this. Here, the detection element 200 is provided at the cover 160, but the present disclosure is not particularly limited to this. Here, an example in which the detection element is provided at a location other than the cover 160 is described with reference to FIG. 17. FIG. 17 is a cross-sectional view of the main part of a modification of the liquid ejecting head H.

As shown in FIG. 17, the liquid ejecting head H includes the holder 130, the head chip Hc, the cover 160, and the like, as in the first embodiment above. The detection element 209 includes an electrode 210B disposed at the face, of the head chip Hc, facing −Z direction and an electrode 210A disposed at the bottom face of the accommodation portion 131 of the holder 140. Such a detection element 209 includes, for example, a capacitance type pressure sensor. The detection element 209 may include a resistance film type pressure sensor.

The top face of the head chip Hc and the bottom face of the accommodation portion 131 of the holder 130 are bonded by an adhesive (not shown). In other words, when an external force toward the −Z direction acts on the portion, of the cover 160, that overlaps the accommodation portion 131 in the plan view when viewed in the Z axis direction, the cover 160 is bent in the −Z direction with the inner edge of the accommodation portion 131 as a starting point, which causes the aforementioned adhesive layer between the head chip Hc and the holder 130 to collapse, so that the head chip Hc moves in the −Z direction toward the bottom of the accommodation portion 131. In other words, the detection element 209 can detect the deformation of the cover 160 by detecting the capacitance when the distance of the gap between the electrode 210A and the electrode 210B changes due to movement of the head chip Hc.

In the first and the second embodiments described above, the detection element 200 is disposed along the X axis direction, which is the longitudinal direction of the head chip Hc, but the present disclosure is not particularly limited to this. For example, when the plurality of head chips Hc is disposed side by side along the Y axis direction, the detection element may be disposed along the Y axis direction. This allows the detection element to detect the deformation of the cover 160 along the Y axis direction, and misalignment of the head chips Hc disposed in the Y axis direction can be detected. Specifically, when the plurality of head chips Hc is disposed side by side in the Y axis direction with the same position in the X axis direction, the detection element are disposed along the Y axis direction, so that it is possible to detect misalignment of the plurality of head chips Hc due to deformation of the cover 160. Of course, the detection elements may be provided along both the X axis direction and the Y axis direction. The detection element along the X axis direction and the detection element along the Y axis direction may be electrically independent, or the detection element along the X axis direction and the detection element along the Y axis direction may be electrically coupled. When the detection element along the X axis direction and the detection element along the Y axis direction are electrically independent, it is possible to determine whether the deformation of the cover 160 is a deformation along the X axis direction or a deformation along the Y axis direction, and detect the anomaly of the liquid ejecting head H with high accuracy. When the detection element along the X axis direction and the detection element along the Y axis direction are electrically coupled, the number of parts can be reduced to lower costs.

Part of the detection element 200 may be provided in the first region 164 and the second region 165, or all of the detection element 200 may be provided in at least one of the first region 164 and the second region 165.

For example, in the first embodiment described above, the holder 130 is illustrated as having the holder body 140 and the reinforcement plate 150, but the present disclosure is not particularly limited to this. The holder 130 may have a configuration without the reinforcement plate 150, that is, a configuration including only the holder body 140. In this case, the first wall 142 of the holder body 140 is an example of a “wall” and the first recess 141 is an example of an “accommodation portion”.

In the first and second embodiments described above, the detection element 200 is provided independently for each head chip Hc, and the detection element 201 is provided independently of the detection element 201, but the present disclosure is not particularly limited to this. For example, at least two or more of the four detection elements 200 may be electrically coupled. In this case, the deformation of the cover 160 around each head chip Hc cannot be detected, but by combining the detection result of the detection element 201, the deformation of the cover 160 around each head chip Hc can be estimated. Of course, at least one detection element 200 may be electrically coupled to the detection element 201. By electrically coupling the detection elements 200 and 201, the number of parts such as the detection element wiring 203 can be reduced to lower costs and the space for wiring the detection element wiring 203 can be reduced to make the liquid ejecting head H compact.

In the first embodiment described above, at least part of the detection element 200 is provided in the third region 166, but the detection element 200 may not be provided in the third region 166. For example, the detection element 200 may be provided in the second region 165, which is less sensitive than in the first embodiment, but makes it possible to detect the deformation of the cover 160.

In the first embodiment described above, each of the first to the third relay boards 181 to 183 is an example of a “relay board” with the detection element wiring 203 coupled to the detection element 200 and wiring for the drive signal for driving the drive element for ejecting a liquid, but the present disclosure is not limited to this. For example, when the detection element wiring 203 is electrically coupled to the wiring board 110 having the wiring for the drive signal of the head chip Hc, the wiring board 110 of this head chip Hc is also an example of the “relay board”.

In the first embodiment described above, the thin-film type piezoelectric actuator 300 is used as a drive element that causes a change in pressure in the pressure chamber 12, but the present disclosure is not limited to this. For example, a thick-film piezoelectric actuator formed by the method of attaching the green sheet, a longitudinal vibration-type piezoelectric actuator that is made by alternately stacking the piezoelectric material and the electrode-forming material to expand and contract the stacked materials in the axial direction, or the like can be used as a drive element. An actuator that disposes a heat-generating element in the pressure chamber 12 and ejects droplets from the nozzle 21 by bubbles generated by the heat generated by the heat-generating element, a so-called electrostatic actuator that generates static electricity between the vibration plate and the electrodes and causes the vibration plate to deform by electrostatic force to eject droplets from the nozzle 21, or the like can be used as a drive element.

Furthermore, the present disclosure is intended for the entire liquid ejecting apparatus that includes the liquid ejecting head in general. Examples of the liquid ejecting head include recording heads such as various ink jet recording heads used in an image recording device such as a printer, and a color material ejecting head used in the manufacture of the color filter such as the liquid crystal display and the like. The liquid ejecting head include, for example, an electrode material ejecting head used for electrode formation in an organic EL display, an FED (field emission display), and a bioorganic material ejecting head used in biochip production, and can be applied to the liquid ejecting apparatus including any of the above liquid ejecting heads.

### Supplementary Note

From the above example forms, the following configurations are conceivable, for example.

A liquid ejecting head according to a first aspect that is a suitable aspect includes a first head chip that ejects a liquid, a cover having a first face and a second face that is a face opposite the first face and to which the first head chip is fixed, an a first detection element that detects a deformation of the cover. According to the aspect, since the detection element can detect the cover deformation, various anomalies, of the liquid ejecting head, represented by a printing defect caused by the cover deformation, can be detected.

In a second aspect that is a specific example of the first aspect, the first detection element is disposed at the cover. According to the aspect, by providing the detection element on the cover, the deformation of the cover can be detected with high accuracy.

In a third aspect that is a specific example of the second aspect, the first detection element is disposed at the second face of the cover. According to the aspect, a medium is less likely to collide with the detection element than a medium when the detection element is provided at the first face, and the detection element is easier to dispose.

In a fourth aspect that is a specific example of the first aspect, liquid ejecting head further includes a holder that holds the first head chip between the holder and the cover and has a wall fixed to the second face.

In a fifth aspect that is a specific example of the fourth aspect, the first detection element is disposed at the cover, and at least part of the first detection element is disposed in a region of the cover, the region being outside of a first region where the wall is fixed. According to the aspect, the detection element is provided in a region, of the cover, that is not supported by the wall and is easily deformed, so that the accuracy of detection of the cover deformation can be improved.

In a sixth aspect that is a specific example of the fifth aspect, the cover includes a second region where the first head chip is fixed and a third region between the first region and the second region, and at least part of the first detection element is disposed in the third region. According to the aspect, the detection element is provided in a region, of the cover, that is not supported by the first head chip or the wall and is easily deformed, so that the deformation of the cover can be detected with high accuracy.

In a seventh aspect that is a specific example of the sixth aspect, the first detection element is disposed in a portion of the third region, the portion being located along a longitudinal direction of the first head chip. According to the aspect, the detection element is provided along the longitudinal direction, of the first head chip, in which misalignment of landing of droplets on and destruction of the medium due to a stress caused by the cover deformation is likely to occur, so that the accuracy of detection of a defect of the first head chip due to the cover deformation can be improved.

In an eighth aspect that is a specific example of the first aspect, the first detection element is disposed along a longitudinal direction of the first head chip. According to the aspect, the detection element is provided along the longitudinal direction, of the first head chip, in which misalignment of landing of droplets on and destruction of the medium due to a stress caused by the cover deformation is likely to occur, so that the accuracy of detection of a defect of the first head chip due to the cover deformation can be improved.

In a ninth aspect that is a specific example of the third aspect, the liquid ejecting head further includes a second head chip that ejects a liquid, and a second detection element that is disposed at the second face and detects a deformation of the cover. According to the aspect, since it is possible to detect an anomaly due to the cover deformation for each head chip, a head chip that is damaged or is likely to be damaged can be identified. Thus, it is possible to detect a head chip that is required to be replaced to regenerate the liquid ejecting head.

In a tenth aspect that is a specific example of the ninth aspect, the liquid ejecting head further includes a holder that holds the first head chip and the second head chip between the holder and the cover and has a wall fixed to the second face, the first head chip and the first detection element are accommodated in a first accommodation space defined by the wall, and the second head chip and the second detection element are accommodated in a second accommodation space defined by the wall, the second accommodation space and the first accommodation space having a partition therebetween. According to the aspect, an anomaly due to the cover deformation can be detected by the detection element corresponding to each head chip.

In an eleventh aspect that is a specific example of the ninth aspect, the liquid ejecting head further includes a holder that holds the first head chip and the second head chip between the holder and the cover and has a wall fixed to the second face, the first head chip and the second head chip are accommodated in a common accommodation space defined by the wall, and the first detection element and the second detection element are a common detection element disposed between the first head chip and the second head chip. According to the aspect, it is possible to reduce the number of detection elements, thereby reducing cost, and reducing the space required to provide the detection elements to achieve miniaturization.

In a twelfth aspect that is a specific example of the first aspect, the first detection element is a conductive resistive element. According to the aspect, it is possible to easily detect the deformation of the cover by the first detection element, which is a conductive resistive element.

In a thirteenth aspect that is a specific example of the first aspect, the liquid ejecting head further includes a relay board having relay wiring coupled to the first detection element and wiring for a drive signal for driving a drive element for ejecting a liquid. According to the aspect, by providing the relay wiring and the drive signal wiring at one relay board, the number of parts can be reduced to lower costs and the space required to provide a plurality of relay boards can be reduced to achieve miniaturization.

A liquid ejecting apparatus according to a fourteenth aspect that is a suitable aspect includes the liquid ejecting head according to the above aspects, and a notification unit that notifies a user that an anomaly has occurred in the liquid ejecting head based on a detection signal from the first detection element. According to the aspect, the detection element can detect the deformation of the cover, and the notification unit can notify the user that an anomaly has occurred in the liquid ejecting head, so that various anomalies, of the liquid ejecting head, represented by a printing defect caused by the cover deformation, can be detected.

What is claimed is:

1. A liquid ejecting head comprising:
a first head chip configured to eject a liquid;
a cover having a first face and a second face that is opposite from the first face and to which the first head chip is fixed; and
a first detection element configured to detect a deformation of the cover.

2. The liquid ejecting head according to claim 1, wherein
the first detection element is disposed at the cover.

3. The liquid ejecting head according to claim 2, wherein
the first detection element is disposed at the second face of the cover.

4. The liquid ejecting head according to claim 1, further comprising:
a holder that holds the first head chip between the holder and the cover and has a wall fixed to the second face.

5. The liquid ejecting head according to claim 4, wherein
the first detection element is disposed at the cover, and wherein
at least part of the first detection element is disposed in a region of the cover that is different from a first region of the cover where the wall is fixed.

6. The liquid ejecting head according to claim 5, wherein
the cover includes a second region where the first head chip is fixed and a third region between the first region and the second region, and wherein
at least part of the first detection element is disposed in the third region.

7. The liquid ejecting head according to claim 6, wherein
the first detection element is disposed in a portion of the third region, the portion being located along a longitudinal direction of the first head chip.

8. The liquid ejecting head according to claim 1, wherein
the first detection element is disposed along a longitudinal direction of the first head chip.

9. The liquid ejecting head according to claim 3, further comprising:
a second head chip that ejects a liquid; and
a second detection element that is disposed at the second face and is configured to detect a deformation of the cover.

10. The liquid ejecting head according to claim 9, further comprising:
a holder that holds the first head chip and the second head chip between the holder and the cover and has a wall fixed to the second face, wherein
the first head chip and the first detection element are accommodated in a first accommodation space defined by the wall, and wherein
the second head chip and the second detection element are accommodated in a second accommodation space defined by the wall, the second accommodation space and the first accommodation space having a partition therebetween.

11. The liquid ejecting head according to claim 9, further comprising:
a holder that holds the first head chip and the second head chip between the holder and the cover and has a wall fixed to the second face, wherein
the first head chip and the second head chip are accommodated in a common accommodation space defined by the wall, and wherein
the first detection element and the second detection element are a common detection element disposed between the first head chip and the second head chip.

12. The liquid ejecting head according to claim 1, wherein
the first detection element is a conductive resistive element.

13. The liquid ejecting head according to claim 1, further comprising:
a relay board having relay wiring coupled to the first detection element and wiring for a drive signal for driving a drive element for ejecting a liquid.

14. A liquid ejecting apparatus comprising:
the liquid ejecting head according to claim 1; and
a notification unit that notifies a user that an anomaly has occurred in the liquid ejecting head based on a detection signal from the first detection element.
